(19) United States
(12) Patent Application Publication
(10) Pub. No.: US 2026/0365556 A1
(43) Pub. Date: Nov. 19, 2026

(54) APPRATUS FOR PRODUCING GLASS, GLASS-CERAMIC AND/OR GLASS-CERAMIC MATERIAL

(71) Applicant: Schott AG, Mainz (DE)

(72) Inventors: Ulrich Lange, Mainz (DE); Frank Büllesfeld, Mainz (DE); Petra Illing-Zimmermann, Mainz (DE); Stefan Knoche, Mainz (DE); Axel Ohlinger

(73) Assignee: Schott AG, Mainz (DE)

(21) Appl. No.: 19/515,694

(22) PCT Filed: Aug. 19, 2024
(86) PCT No.: PCT/EP2024/073223

§ 371 Date: Mar. 2, 2026

(30) Foreign Application Priority Data
Sep. 1, 2023 (DE) 10 2023 208 453.8
Jan. 16, 2024 (EP) 24152167.3

(51) Int. Cl. C03B 13/14; C03B 7/094

(52) U.S. Cl. CPC C03B 13/14; C03B 7/094

(57) ABSTRACT

The invention relates to an apparatus for producing glass, glass ceramic and/or glass ceramic material, comprising a feed device for supplying a strip having a viscosity of between 0.01 Pa's and 100 Pas to a shaping device. The shaping device comprises at least one mobile discharge surface, and a velocity of the mobile discharge surface is 90% or more and 200% or less than a velocity of the supplied strip in the region where the strip meets the mobile discharge surface. This enables provision of a stable strip of low-viscosity glass. The described minimum throughput is applicable to this end.

### CROSS-REFERENCE TO RELATED APPLICATIONS

This application is a national stage entry under 35 U.S.C. § 371 of International Patent Application No. PCT/EP2024/073223 filed on Aug. 19, 2024, which is incorporated in its entirety herein by reference. International Patent Application No. PCT/EP2024/073223 claims priority to European Patent Application No. 24152167.3 filed on Jan. 16, 2024, which is incorporated in its entirety herein by reference. International Patent Application No. PCT/EP2024/073223 also claims priority to German Patent Application No. 10 2023 208 453.8 filed on Sep. 1, 2023, which is incorporated in its entirety herein by reference.

### BACKGROUND OF THE INVENTION

### 1. Technical Field of the Invention

The invention relates to an apparatus for producing glass, glass-ceramic and/or glass-ceramic material, comprising a feeding device for feeding a lamella of a glass melt to a shaping device, wherein the shaping device comprises at least one movable, more particularly rotatable, discharge surface. There may be a drawing device downstream of the shaping device.

The invention further relates to a method for producing glass, glass-ceramic and/or glass-ceramic material.

The invention additionally relates to a glass product produced from substrate comprising glass, glass-ceramic and/or glass-ceramic material.

The glass is produced more particularly from the glass melt. The term “glass” here encompasses generally glass, glass-ceramic and/or glass-ceramic material.

### 2. Description of the Related Art

WO 2021/221910 A1 has disclosed an apparatus and a method for producing low-viscosity glass plates having a liquidus viscosity of less than 5 kP. The method involves forming a glass ribbon of glass having a liquidus viscosity <5 kP and causing the glass ribbon to flow onto a surface of a molten metal bath in a tank. The tank has a length of less than 500 cm. The glass ribbon flows over the length of the tank in a downward direction from the first end to the second end of the tank in such a way that the glass ribbon reaches its equilibrium thickness at the second end and the viscosity of the glass ribbon at the second end is at least 100 kP. The molten glass ribbon is then fed to a cooling roller. The cooling roller removes heat from the glass ribbon, which is consequently cooled.

A disadvantage of this is that at low liquidus viscosity, the glass ribbon tends to break apart into individual strands, which results in high costs and time-consuming production of the glass.

### SUMMARY OF THE INVENTION

An object of the present invention is therefore to provide an apparatus for producing glass, glass-ceramic and/or glass-ceramic material, a method for producing glass, glass-ceramic and/or glass-ceramic material, and a glass product, which are producible or can be produced easily and inexpensively, which enable a stable lamella in particular at high throughput, especially for glasses which have a low liquidus viscosity.

A further object of the present invention is therefore to provide an alternative apparatus for producing glass, glass-ceramic and/or glass-ceramic material, an alternative method for producing glass, glass-ceramic and/or glass-ceramic material, and an alternative glass product.

In one embodiment, the present invention achieves the above-stated objects with an apparatus for producing glass, glass-ceramic and/or glass-ceramic material, comprising a feeding device for feeding a lamella having a viscosity of between 0.01 Pa s and 100 Pa s to a shaping device, wherein the shaping device comprises at least one movable, more particularly rotatable, discharge surface, and wherein a velocity, more particularly tangential velocity, of the movable, more particularly rotatable, discharge surface corresponds to 90% or more, preferably 95% or more, in particular 98% or more, preferably 99% or more and 200% or less, preferably 175% or less, in particular 150% or less, preferably 125% or less, in particular 120% or less, preferably 110% or less, in particular 105% or less, preferably 101% or less of a velocity of the fed lamella in the region of impingement of the lamella on the movable, more particularly rotatable, discharge surface.

In one embodiment, the present invention achieves the above-stated objects with a method for producing glass, glass-ceramic and/or glass-ceramic material, comprising the steps of
providing a lamella having a viscosity of between 0.01 Pa s and 100 Pa s by a feeding device,
feeding the provided lamella to at least one movable, more particularly rotatable, discharge surface of a shaping device by means of the feeding device,
providing a velocity of the fed lamella and a velocity, more particularly tangential velocity, of the movable, more particularly rotatable, discharge surface relative to the lamella in the region of impingement of the lamella on the discharge surface in such a way that a velocity, more particularly tangential velocity, of the movable, more particularly rotatable, discharge surface corresponds to 90% or more, preferably 95% or more, in particular 98% or more, preferably 99% or more and 200% or less, preferably 175% or less, in particular 150% or less, preferably 125% or less, in particular 120% or less, preferably 110% or less, in particular 105% or less, preferably 101% or less of the velocity of the fed lamella in the region of impingement of the lamella on the movable, more particularly rotatable, discharge surface.

In one embodiment, the present invention achieves the above-stated objects with a glass product produced from a glass melt comprising glass, glass-ceramic and/or glass-ceramic material, more particularly produced with an apparatus as claimed in any of the apparatus claims and/or with a method as claimed in any of the method claims, wherein the glass product has at least one, preferably two or more, more particularly all, of the following properties:
a roughness Ra on at least one side of the glass product of 0.1 nanometer or more, in particular 1 nanometer or more, preferably 10 nanometers or more, in particular 100 nanometers or more and 200 μm or less, preferably 100 μm or less, in particular 50 μm or less, preferably 30 μm or less, in particular 25 μm or less, preferably 20 μm or less, wherein the roughness is specified relative to an area of the glass product of 50×50 μm² or more, preferably 100×100 μm² or more, in particular 200×200 μm² or more, preferably 250×250 μm² or more, in particular 500×500 μm² or more, preferably 750×750 μm² or more, preferably between 900×900 μm² and 1000×1000 μm² and less than 1000×1000 μm²
a liquidus viscosity of 100 Pa s or less and a crystal growth rate of 0.4 μm/min or more, preferably 0.5 μm/min or more, in particular 1.0 μm/min or more, in particular 2.5 μm/min or more, preferably 3.0 μm/min or more, in particular 4.0 μm/min or more, in particular 4.5 μm/min or more and/or 10.0 μm/min or less, preferably 7.5 μm/min or less, in particular 5.0 μm/min or less
at least one side of the glass product is fire-polished.

In one embodiment, the present invention achieves the above-stated objects through the use of a glass product as a cover glass or optical element in an augmented reality device.

A glass product may be produced by means of the apparatus as claimed and/or with a method as claimed.

An augmented reality device may comprise, for example, augmented reality glasses.

### BRIEF DESCRIPTION OF THE DRAWINGS

Preferred configurations and embodiments of the present invention are shown in the drawings and are explained in more detail in the following description.

In these drawings, in schematic form,

FIG. 1 shows an apparatus according to one embodiment of the present invention;

FIG. 2 shows steps of a method according to one embodiment of the present invention;

FIG. 3 shows a diagram of the normalized throughput of a lamella as a function of the Ohnesorge number; and

FIGS. 4a-4c show apparatuses with drawing process.

### DETAILED DESCRIPTION OF THE INVENTION

The term “glass” is to be understood in the broadest sense, and in particular in the claims, preferably in the description, it encompasses glass, glass-ceramic and/or glass-ceramic material.

The term “lamella” is to be understood in the broadest sense and refers, in particular in the claims, preferably in the description, to a glass ribbon and/or a glass layer which passes from a glass melt in the liquid state onto components of an apparatus for the onward processing of the lamella. The lamella here is preferably to be maintained and not tear off, which is problematic particularly for glasses having a low liquidus viscosity. The lamella within the meaning of the invention is therefore understood in particular to be the hot glass, which is supplied in particular to the melting device of the shaping device. Lamella refers in particular to the region of the glass material from leaving the feeding device up to the impingement region.

Subsequently, the glass and/or worked material is referred to as substrate.

One of the advantages of the invention thus achieved is that a stable lamella can be provided at a very low viscosity of the glass ribbon, which enables the production of an inexpensive glass product. Another advantage is that it enables efficient production or shaping of glasses having low viscosity.

Further features, advantages and further embodiments of the invention are described in or rendered obvious by the text below.

According to one advantageous development, the feeding device and shaping device are configured, depending on the Ohnesorge number,

$$Oh = \frac{η}{\sqrt{2 γρ D}}$$

to provide, for the lamella, a minimum throughput rh according to the formula

$$\dot{m} ( Oh ) = B \sqrt{2 γρ D} \frac{1 + b \cdot {Oh}^{3}}{1 + a \cdot {Oh}^{3} + b \cdot {Oh}^{4}}$$

wherein ρ is the density of the lamella, B the width of the lamella, D the thickness of the lamella, η the viscosity of the lamella, and γ the surface tension, and the parameters a, b≥0. An advantage of this is that a minimum throughput for a stable lamella can be provided in a particularly reliable manner for a wide variety of glass compositions, especially those having a low viscosity at the feed temperatures. In principle, the higher the throughput, the more stable the lamella. However, a high throughput is difficult for the handling of the substrate. Therefore, the minimum throughput provided here is an advantageous tradeoff, which on the one hand provides a stable lamella and on the other enables a rationally manageable throughput.

Within the scope of this description and the claims, it is generally the case that B and D are each measured at the point where the glass and/or glass-ceramic material leaves the feeding device, in particular immediately after leaving the nozzle, or in other words at the beginning of the lamella.

According to a further advantageous development, the parameter a has a magnitude of between 5 and 500, preferably between 70 and 500, preferably between 100 and 400, preferably between 200 and 250, in particular 230, and the parameter b has a magnitude of between 0 and 200, preferably between 25 and 200, preferably between 25 and 100, preferably between 50 and 90, in particular 83. An advantage of this is that an exact specification of a minimum throughput can be provided.

According to a further advantageous development, the shaping device is configured in such a way that the substrate on leaving the discharge surface has a viscosity of 10² Pa s or more, in particular 104 Pa s or more, preferably 105 Pa s or more, in particular from 10² Pa s to 10⁸ Pa s or from 10² Pa s to 105 Pa s. An advantage of this is that it ensures sufficient workability of the glass ribbon after traversal of the substrate. Another advantage is that the glass traverses the crystallization region quickly, so that the crystal growth is reduced to a minimum or prevented and the glass is nevertheless sufficiently shapable to be deflected and/or formed. The said region includes that in particular the thickness of the substrate is adjusted by the shaping device, or after the discharge surface has been left, a drawing device is provided by which the glass thickness is at least proportionally adjusted.

According to a further advantageous development of the invention, the discharge surface is configured in the form of a rotatable roller and/or a movable conveyor belt and/or a movable chain. An advantage of this is a simple and cost-effective provision of a discharge surface.

According to a further advantageous development of the invention, the substrate, based on the overall circumference of a rotatable discharge surface, loops around the rotatable discharge surface to an extent of at least 1%, preferably at least 2%, in particular at least 5%, preferably 10% or more and 75% or less, preferably 40% or less, in particular 25% or less. An advantage of this is that a greater influence on the substrate, for example in the form of a cooling, can be provided by means of the rotating discharge surface.

According to a further advantageous development of the invention, the feeding device has a slot-shaped nozzle, wherein the slot-shaped nozzle has a maximum width of between 0.05 m and 4 m, in particular between 0.25 and 1 m, preferably between 0.3 m and 0.4 m, a maximum depth of between 1 mm and 50 mm, preferably between 5 mm and 25 mm, and a slot width of between 0.2 mm and 5 mm, preferably between 1 mm and 3 mm. An advantage of this is that a sufficient throughput and at the same time a particularly stable lamella can be provided.

According to a further advantageous development of the invention, a temperature conditioning device is arranged for temperature-conditioning at least the shaping device, more particularly for cooling. An advantage of this is a particularly reliable provision of a substrate. Temperature-conditioning the surface is particularly advantageous for controlling adhesives and adhesions at the discharge surface.

According to a further advantageous development of the invention, the shaping device is configured to provide a contact time of the substrate with the discharge surface of 0.01 s or more, in particular 0.02 s or more, preferably 0.1 s or more, in particular 0.5 s or more and 10 s or less, preferably 5 s or less, in particular 2 s or less. One of the advantages achieved by this is that, for example, temperature conditioning by means of the shaping device can be adapted according to the respective type of glass used and its crystallization characteristics.

According to a further advantageous development of the invention, the feeding device and shaping device are configured so that, depending on the Ohnesorge number,

$$Oh = \frac{η}{\sqrt{2 γρ D}}$$

for the lamella, a minimum throughput is provided according to the formula (see above)

$$\dot{m} ( Oh ) = B \sqrt{2 γρ D} \frac{1 + b \cdot {Oh}^{3}}{1 + a \cdot {Oh}^{3} + b \cdot {Oh}^{4}}$$

wherein ρ is the density of the lamella, B the width of the lamella, D the thickness of the lamella, η the viscosity of the lamella, and γ the surface tension of the lamella, and the parameters a, b≥0. An advantage of this is that a minimal throughput can be provided in a particularly reliable manner for a wide variety of glass materials.

According to a further advantageous development of the invention, for the parameter a, a magnitude is selected of between 5 and 500, preferably between 70 and 500, preferably between 100 and 400, preferably between 200 and 250, in particular 230, and for the parameter b, a magnitude is selected of between 0 and 200, preferably between 25 and 200, preferably between 25 and 100, preferably between 50 and 90, in particular 83. An advantage of this is that an exact specification of a minimum throughput can be provided.

According to a further advantageous development of the invention, the substrate, based on the overall circumference of a rotatable discharge surface, loops around the rotatable discharge surface to an extent of at least 1%, preferably at least 2%, in particular at least 5%, preferably 10% or more and 75% or less, preferably 40% or less, in particular 25% or less. An advantage of this is that a greater influence on the substrate, for example in the form of a cooling, can be provided by means of the rotating discharge surface.

According to a further advantageous development, the contact time of the substrate with the discharge surface is selected to be 0.01 s or more, in particular 0.02 s or more, preferably 0.1 s or more, in particular 0.5 s or more and 10 s or less, preferably 5 s or less, in particular 2 s or less. One of the advantages achieved by this is that, for example, temperature conditioning by means of the shaping device can be adapted according to the respective type of glass used and its crystallization characteristics.

According to a further advantageous development of the invention, the surface of the arriving lamella is fire-polished, in particular because the lamella is sufficiently hot and has a low viscosity. An advantage of this is that a particularly low surface roughness of the resulting glass product can be provided in this way. For example, a roughness Ra on at least one side of the glass product of 0.1 nanometer or more, in particular 1 nanometer or more, preferably 10 nanometers or more, in particular 100 nanometers or more and 200 μm or less, preferably 100 μm or less, in particular 50 μm or less, preferably 30 μm or less, in particular 25 μm or less, preferably 20 μm or less, can be provided in this way, wherein the roughness is specified relative to an area of the glass product of 50×50 μm² or more, preferably 100×100 μm² or more, in particular 200×200 μm² or more, preferably 250×250 μm² or more, in particular 500×500 μm² or more, preferably 750×750 μm² or more, preferably between 900×900 μm² and 1000×1000 μm² and less than 1000×1000 μm².

According to a further advantageous development, at least one side of the glass product is fire-polished. An advantage of this is that a particularly high-quality glass product with low surface roughness can be provided.

The process is particularly advantageously performed such that the substrate is fed to and/or subjected to a drawing process after contact with the shaping tool. This has the advantage that the thickness of the glass substrate is finally adjusted during the drawing process. The initial adjustment is done, so to speak, via the shaping tool, and the fine adjustment via the drawing process. It has emerged that particularly good process stabilities can be achieved in this way, since fine adjustment of the thickness can be made independently of and without any effect on the optimal adjustment of the lamella. Advantageously, thicknesses of 10 μm to 3 mm are obtained, in particular from 30 μm to 3 mm or from 100 μm to 1 mm.

In addition to the stated conditions and/or parameters for the feeding of the lamella to the shaping device, the process regime can for this purpose be particularly advantageously adjusted such that the substrate on leaving the shaping device meets one or more of the following conditions:
The relaxation time for the reduction of internal stresses is adjusted such that warping and/or shattering of the substrate is avoided. This is generally achieved by selecting a short relaxation time.
The viscosity of the substrate must be sufficiently low to correct the curvature of the shaping tool; i.e., the substrate after the shaping tool should advantageously be able to be shaped flat or stretched. The stretching of the substrate can be associated with a reduction in thickness. Glass contact rollers may be advantageous for this stretching. These rollers may contact the glass before further cooling or else only in the solid state, i.e., particularly advantageously in a viscosity range of >10⁷ Pa s or >10¹² Pa s.
The viscosity of the substrate on leaving the discharge surface is particularly advantageously in a range from 10² Pa s to 10⁵ Pa s, in particular from 10² Pa s to 10⁴ Pa s, particularly advantageously in the range from 10³ Pa s to 10⁴ Pa s. This allows fire-polished surfaces, in particular on both sides, and/or flat shaping and/or stretching with further thickness reduction to be achieved.

To support the process of detaching the substrate from the shaping tool, fluid nozzles/air nozzles can advantageously be used. Fluid nozzles can in particular transport gases onto the substrate, in the simplest case air, with the pressure of the fluid supporting the detachment of the substrate. Accordingly, in the simplest case, the fluid nozzle is an air nozzle.

After shaping, the substrate can be cooled with an adapted cooling curve, in particular in order to set the specified viscosities.

Further important features and advantages of the invention are apparent from the dependent claims, from the drawings, and from the associated description of the figures.

It is understood that the features mentioned above and those hereinbelow yet to be elucidated may be used not just in the combination indicated in each case, but also in other combinations or on their own, without departure from the scope of the present invention.

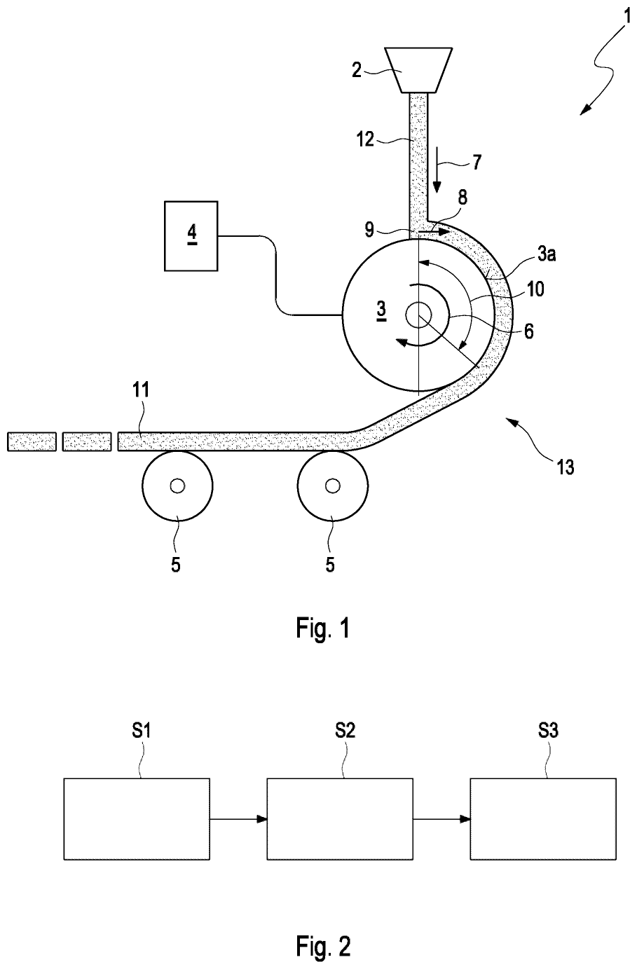

FIG. 1 shows in schematic form an apparatus 1 for producing glass, glass-ceramic and/or glass-ceramic material. This apparatus 1 comprises a feeding device in the form of a slot-shaped nozzle 2 for forming and feeding a lamella 12 of a glass material, which is configured here in the form of a ribbon or a glass melt, for a shaping device 13. The lamella 12 has a viscosity of between 0.01 Pa s and 100 Pa s. The lamella 12 falls in free fall starting from the nozzle 2 onto the shaping device 13 arranged beneath it. The shaping device 13 has a discharge roller 3, which comprises a rotatable discharge surface 3a with a clockwise direction of rotation 6. Alternatively, the discharge surface 3a may also be configured as a movable belt or movable chain.

In this case, the velocity 8 of the movable, more particularly rotatable, discharge surface 3a in the region 9 of impingement of the lamella 12 on the discharge surface 3a corresponds to 90% or more, preferably 95% or more, in particular 98% or more, preferably 99% or more and 200% or less, preferably 175% or less, in particular 150% or less, preferably 125% or less, in particular 120% or less, preferably 110% or less, in particular 105% or less, preferably 101% or less of the velocity 7 of the fed lamella 12 in the region 9 of impingement of the lamella 12 on the discharge surface 3a.

In general, for very low viscosities of the lamella 12, the impingement velocity of the lamella 12 onto the discharge surface 3a corresponds to the sum of the exit velocity of the lamella 12 from the nozzle 2 and the velocity increase due to the free fall. For higher viscosities, the result is essentially a lower impingement velocity, which can be determined experimentally.

The velocity of the lamella 12 on impingement onto the discharge surface 3a can be measured by tracking bubbles, particles or other marks in the glass melt or liquids of the same viscosity and/or can be determined via numerical calculations. As observed, for very low viscosities, the impingement velocity of the lamella 12 corresponds in good approximation to the formula from a free fall of the lamella 12 with an initial velocity which corresponds essentially to the exit velocity from the nozzle 2. In this case, a deviation may be provided between the stated impingement velocity of the lamella 12 from the velocity of the movable discharge surface 3a. In this case, smaller deviations to slower velocities of the movable discharge surface 3a and larger deviations to faster velocities of the movable discharge surface 3a relative to the velocity of the lamella 12 can be permitted, the latter in order, for example, to reduce the thickness of the lamella 12.

The velocity of the movable discharge surface 3a here may be 90% or more, preferably 95% or more, in particular 98% or more, preferably 99% or more and 200% or less, preferably 175% or less, in particular 150% or less, preferably 125% or less, in particular 120% or less, preferably 110% or less, in particular 105% or less, preferably 101% or less of the velocity of the lamella 12.

The lamella 12, after impinging onto the rotatable discharge surface 3a, is conveyed on from the latter and leaves the rotatable discharge surface as substrate 11 after traversing an angle 5 of around 45 degrees, and this substrate is conveyed on its further course horizontally by means of transport rollers 5 for further working. The loop angle 10 may also have other values, for example between 45 degrees and 235 degrees, preferably between 54 degrees and 216 degrees.

The discharge roller 3 can—as shown in FIG. 1 here—be connected to a temperature conditioning device, here in the form of a cooling device 4. This cooling device 4 cools the discharge roller 3 or, more precisely, the rotatable discharge surface 3a.

Suitable cooling media can be used here for the cooling device 4. Possibilities include, in particular, oil and/or water and/or a water-air mixture.

In a further embodiment, not shown here, the shaping device can comprise a conveyor belt which transports the substrate 11, instead of a discharge roller 3. The conveyor belt in this case can be arranged at an inclination to the horizontal. In a further embodiment, not shown here, the shaping device may also have one or more belts and/or one or more discharge rollers.

FIG. 2 shows in schematic form steps of a method according to an embodiment of the present invention.

In FIG. 2, a method for producing glass, glass-ceramic and/or glass-ceramic material is shown in schematic form. This method comprises the steps of
providing S1 a lamella 12 having a viscosity of between 0.01 Pa s and 100 Pa s by a feeding device,
feeding S2 the provided lamella 12 to at least one movable, more particularly rotatable, discharge surface 3a of a shaping device 13 by means of the feeding device, and
providing S3 a velocity, more particularly tangential velocity, of the movable, more particularly rotatable, discharge surface 3a relative to the exit nozzle 2 in the region 9 of impingement of the lamella 12 on the movable, more particularly rotatable, discharge surface 3a in such a way that a velocity, more particularly tangential velocity, of the movable, more particularly rotatable, discharge surface 3a corresponds to 90% or more, preferably 95% or more, in particular 98% or more, preferably 99% or more and 200% or less, preferably 175% or less, in particular 150% or less, preferably 125% or less, in particular 120% or less, preferably 110% or less, in particular 105% or less, preferably 101% or less of the velocity of the fed lamella 12 in the region 9 of impingement of the lamella 12 on the movable, more particularly rotatable, discharge surface 3a.

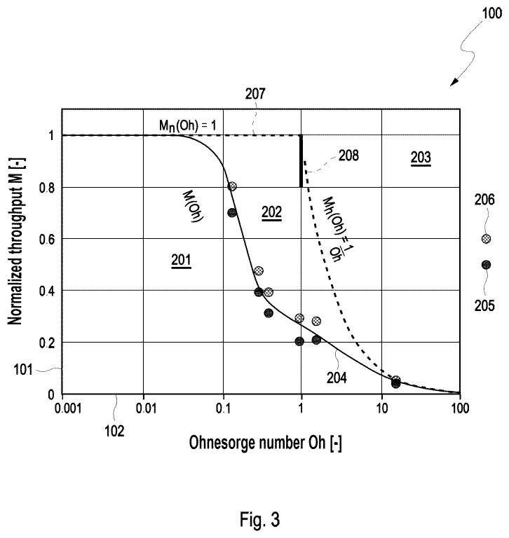

FIG. 3 shows a diagram of the normalized throughput of a lamella as a function of the Ohnesorge number.

The normalized throughput here is defined as follows:

$$M = \frac{\dot{m}}{B \sqrt{2 γρ D}}$$

where rh is the mass throughput, B the lamella width, γ the surface tension, D the thickness of the lamella, and ρ the density of the glass.

FIG. 3 shows a diagram 100, wherein the normalized throughput M 101 is shown on the y-axis and the Ohnesorge number Oh is shown on a logarithmic scale on the x-axis 102.

The curve 204, which is represented essentially by the general formula

$$\dot{m} ( Oh ) = \frac{1 + b \cdot {Oh}^{3}}{1 + a \cdot {Oh}^{3} + b \cdot {Oh}^{4}}$$

is the limiting throughput 204 at which the corresponding lamella is just still stable. In this case, the regions 202, 203 of the diagram 100 represent stable regions in which the throughput 101 of the lamella as a function of the Ohnesorge number is stable. These ranges 202, 203 lie above the limiting throughput 204. The region 201 below the limiting throughput 204 represents the unstable range, meaning that here, as a function of the Ohnesorge number, the lamella is unstable. Measuring points are specified for the respective regions 201, 202, 203: points 205 for the region 201, points 206 for the region 202.

Additionally marked are the limiting cases of “low viscosity”, in which the Ohnesorge number tends to 0, wherein the normalized throughput then has the magnitude 1, reference sign 207, and “high viscosity”, in which the Ohnesorge number tends to infinity, wherein the normalized throughput then runs inversely proportional to the Ohnesorge number, reference sign 208.

Based on corresponding tests, represented by points 205, 206, it was possible to find the two freely selectable parameters a, b in the

$$M ( Oh ) = \frac{1 + b \cdot {Oh}^{3}}{1 + a \cdot {Oh}^{3} + b \cdot {Oh}^{4}} .$$

### These are

a≈230,b≈83

and so the limiting throughput 204 as a function of the Ohnesorge number may be described using the function

$$M ( Oh ) = \frac{1 + 83 \cdot {Oh}^{3}}{1 + 230 \cdot {Oh}^{3} + 83 \cdot {Oh}^{4}}$$

In principle, the minimum throughput for a lamella of smaller thickness is lower than the minimum throughput for a lamella of larger thickness.

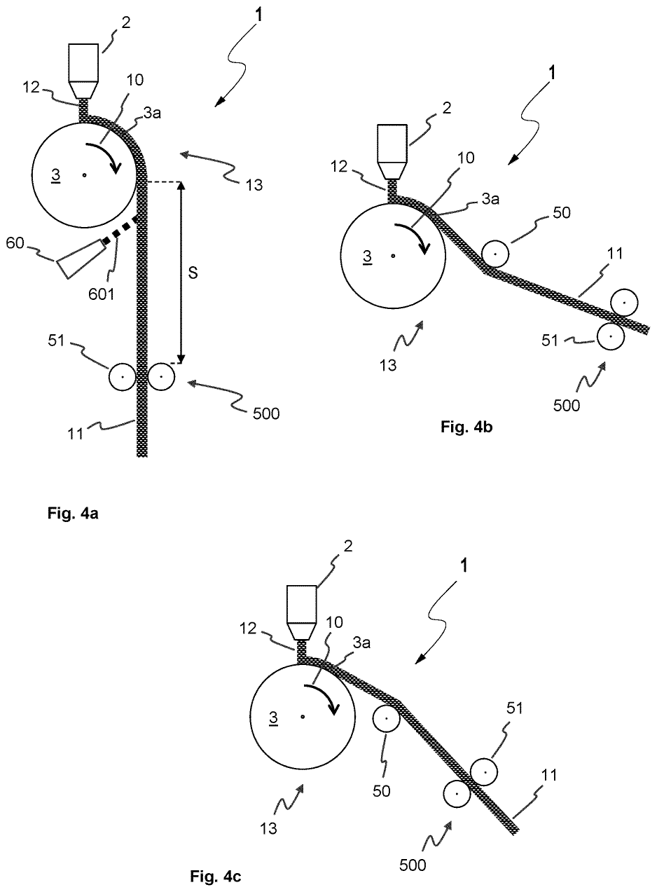

FIGS. 4a to 4c schematically show embodiments of the apparatus 1 and thus embodiments of the method in which a drawing method with a drawing device 500 is disposed downstream of the shaping device 13 as described. Thus the shape and/or the thickness of the substrate 11 and hence of the glass product produced is adjusted in two stages, first preparatively, so to speak, by means of the shaping device 13 and then by means of the drawing device 500, which in particular can comprise one or more drawing rollers and/or drawing cylinders 51. Drawing, also called stretching, can simultaneously smooth the surface of the substrate 11 and thus of the glass product produced.

The drawing rollers are in contact with the substrate 11, which is cooled in particular to an extent such that the contact does not cause any significant deformation of the substrate 11 and/or of the glass product produced.

The conditions and/or parameters described above are also set for this two-stage method. As described, it is advantageously the case that in this two-stage method, the viscosity of the substrate 11 on leaving the shaping unit 13, meaning on leaving the discharge surface 3a, has a viscosity in the range 10² Pa s to 10⁵ Pa s, in particular from 10² Pa s to 10⁴ Pa s, particularly advantageously in the range from 10³ Pa s to 10⁴ Pa s.

In FIG. 4a, an embodiment is shown in which the substrate 11 is drawn from the discharge surface 3a, here by means of the two drawing rollers 51, which are in contact with the substrate 11. The section between the point of leaving the discharge surface 3a and the drawing roller is the temperature conditioning section S, in which the substrate 11 is in particular so cooled and its viscosity so adjusted that the drawing roller 51 itself does not produce any unwanted deformation of the substrate 11.

Of course, at least in regions of the temperature conditioning section S, provision may be made for the substrate 11 to be cooled or heated with suitable devices, for example with cooling units or furnaces. The temperature conditioning sections are also present in the embodiments according to FIGS. 4b and 4c, but for clarity are not shown. The cooling or heating is accordingly also provided in the embodiments corresponding to these figures.

Particularly advantageously, the temperature conditioning section S and/or the cooling or heating are/is designed such that the viscosity of the substrate 11 at the contact point with the drawing roller (51) is >10⁷ Pa s or >10¹² Pa s. This too applies, of course, to all embodiments.

The fluid nozzle 60 is arranged such that a fluid stream 601 emanating from it is directed onto the substrate 11 in the vicinity of the discharge surface, in particular in the vicinity of the point of detachment of the substrate 11 from the discharge surface 3a. The fluid stream exerts, as it were, a pressure on the substrate 11, so that detachment from the discharge surface 3a is supported. Provision may also be made to adjust the temperature of the fluid stream in such a way, in particular also in interaction with the temperature conditioning section, that a desired heating and/or cooling profile of the substrate is achieved. As already described, the fluid can be any suitable fluid; in the simplest case it is, for example, air and the fluid nozzle 60 is then an air nozzle.

In the embodiment according to FIG. 4a, in particular, gravity is also exploited during the drawing process, by the substrate 11 running perpendicularly to the drawing device from the location of detachment from the discharge surface 3a. This means that the location of detachment of the substrate 11 from the discharge surface 3a is in particular advantageously arranged perpendicularly above the drawing device 500, in particular perpendicularly above the midpoint between the two drawing rollers 51.

In the embodiment according to FIG. 4b, a deflection roller 50 is used before the substrate 11 impinges on the drawing device 500. This means that at least partially horizontal arrangements of the apparatus 1 are also possible. The deflection roller 50 also has the advantage that it puts the substrate 11 under tension, as a result of which good surface quality is achievable and the process stability can be improved.

Not depicted is the optional fluid nozzle, which can of course also be provided here. The same applies to FIG. 4c.

In the embodiment according to FIG. 4c, a deflection roller 50 is likewise used, and can also be referred to as a support roller owing to its arrangement below the substrate 11. The advantages stated above also apply to this embodiment.

The glass products that can be produced by means of the apparatus and the production method are based on the possible compositions that follow.

### 1. Composition

All of the data below relate to % by weight on an oxide basis.

| | |
|---|---|
| SiO₂ | 55-75, preferably 62-72 |
| Al₂O₃ | 18-27 |
| Li₂O | 2.8-5, preferably 3-5 |
| Na₂O | 0-4, preferably 0-2 |
| K₂O | 0-4, preferably 0-2 |
| MgO | 0-8, preferably 0-4 |
| CaO | 0-4, preferably 0-2 |
| SrO | 0-4, preferably 0-2 |
| BaO | 0-4, preferably 0-2 |
| ZnO | 0-6, preferably 0-2 |
| TiO₂ | 0-4, preferably 0-3 |
| ZrO₂ | 0-5, preferably 1.2-4 |
| B₂O₃ | 0-2, preferably 0-0.1 |
| In particular, Fe₂O₃ | 0.0001-0.1, preferably 0.0001-0.02 |
| SnO₂ | 0-2, preferably 0.05-1.6 |

where the sum total of the components TiO₂ and ZrO₂ is preferably subject to the following condition:
0<Σ (TiO₂+ZrO₂)<9.5%, preferably 1.2<Σ(TiO₂+ZrO₂)<9.5%
where the components SnO₂, ZrO₂ and TiO₂ are preferably subject to the following condition:
0≤SnO₂/(ZrO₂+TiO₂)<0.8, preferably 0.01≤SnO₂/(ZrO₂+TiO₂)<0.7.

### 2. Composition

All of the data below relate to % by weight on an oxide basis.

| | |
|---|---|
| SiO₂ | 57 to 69, preferably 59 to 69, more preferably 61 to 69, where |
| | the upper limit may preferably be 67 in each case, |
| Al₂O₃ | 17 to 25, preferably 17 to 24, more preferably 17 to 21, |
| B₂O₃ | 0 to 7, preferably 0 to 5, more preferably 0 to 4.5, |
| Li₂O | 3 to 5.5, preferably 3.5 to 5.5, more preferably 3.5 to 5 |
| Na₂O | 0.3 to 7, preferably 0.3 to 6, more preferably 0.8 to 5.5, or even |
| | most preferably from 0.8 to 4.5, |

where preferably the sum total of the content of Al₂O₃ and SiO₂, based on the figure in % by weight, is between at least 75 and at most 92, preferably at most 90.

### 3. Composition

All of the data below relate to % by weight on an oxide basis.

| SiO₂ | 57 to 69, preferably 59 to 69, more preferably 61 to 69, where |
|---|---|
| | the upper limit may preferably be 67 in each case, |
| Al₂O₃ | 17 to 25, preferably 17 to 24, more preferably 17 to 21, |
| B₂O₃ | 0 to 7, preferably 0 to 5, more preferably 0 to 4.5, |
| Li₂O | 3 to 5.5, preferably 3.5 to 5.5, more preferably 3.5 to 5, |
| Na₂O | 0.3 to 7, preferably 0.3 to 6, more preferably 0.8 to 5.5, even |
| | more preferably 0.8 to 4.5, |
| K₂O | 0 to 1, preferably 0 to 0.8, more preferably 0 to 0.7, |
| MgO | 0 to 2, preferably 0 to 1.5, more preferably 0 to 1, |
| CaO | 0 to 4.5, |
| SrO | 0 to 2, preferably 0 to 1.5, more |
| | preferably 0 to 1, |
| ZnO | 0 to 3, preferably 0 to 2, more preferably 0 to 1.5, |
| P₂O₅ | 0 to 3, preferably 0 to 2, more preferably 0 to 1.7, |
| ZrO₂ | 0 to 3, preferably 0 to 2.8, more preferably 0-2.5, very |
| | preferably 0-1, |
| TiO₂ | 0 to 3, preferably 0 to 2.8, more preferably 0-2.5, very |
| | preferably 0-1, |
| SnO₂ | 0 to 2, preferably 0 to 1.5, more preferably 0-1, very preferably |
| | 0-0.8, |

where, additionally, impurities and/or refining agents and/or coloring constituents may be present in amounts of up to 2% by weight and where the abovementioned SnO₂ is a refining agent in the sense of the refining agent additionally present.

### 4. Composition

All of the data below relate to % by weight on an oxide basis.

| | |
|---|---|
| Li₂O | 3.2-5.0 |
| Na₂O | 0-1.5 |
| K₂O | 0-1.5 |
| ΣNa₂O + K₂O | 0.2-2.0 |
| MgO | 0.1-2.2 |
| CaO | 0-1.5 |
| SrO | 0-1.5 |
| BaO | 0-2.5 |
| ZnO | 0-<1.5 |
| Al₂O₃ | 19-25 |
| SiO₂ | 55-69 |
| TiO₂ | 1.0-5.0 |
| ZrO₂ | 1.0-2.5 |
| SnO₂ | 0-<1.0 |
| ΣTiO₂ + ZrO₂ + SnO₂ | 2.5-5.0 |
| P₂O₅ | 0-3.0 |

### 5. Composition

All of the data below relate to % by weight on an oxide basis.

| | |
|---|---|
| Li₂O | 3.5-4.5 |
| Na₂O | 0.2-1.0 |
| K₂O | 0-0.8 |
| ΣNa₂O + K₂O | 0.4 + 1.5 |
| MgO | 0.3-2.0 |
| CaO | 0-1.0 |
| SrO | 0-1.0 |
| BaO | 0-2.5 |
| ZnO | 0-1.0 |
| Al₂O₃ | 19-24 |
| SiO₂ | 60-68 |
| TiO₂ | 1.0-2.0 |
| ZrO₂ | 1.2-2.2 |
| SnO₂ | 0-0.6 |
| ΣTiO₂ + ZrO₂ + SnO₂ | 3.0-4.5 |
| P₂O₅ | 0-2.0 |

### 6. Composition

All of the data below relate to % by weight on an oxide basis.

| | |
|---|---|
| Li₂O | 3-5 |
| Al₂O₃ | 15-25 |
| SiO₂ | 50-75 |
| TiO₂ | 1-5 |
| ZrO₂ | 1-2.5 |
| SnO₂ | 0-1 |
| Σ TiO₂, ZrO₂ and SnO₂ | 2.5-5 |
| MgO | 0.1-2.5 |
| Na₂O | 0-1.5 |
| K₂O | 0-1.5 |
| Σ Na₂O and K₂O | 0.2-2 |
| CaO | 0-2 |
| SrO | 0-2 |
| BaO | 0-3 |

optionally with addition of coloring components such as compounds of V, Cr, Mn, Fe, Co, Cu, Ni, Se or U, or mixtures thereof.

### 7. Composition

All of the data below relate to % by weight.

| | |
|---|---|
| SiO₂ | 6.0 to 35.0 |
| B₂O₃ | 0.0 to 12.0 |
| Nb₂O₅ | 10.0 to 55.0 |
| TiO₂ | 10.0 to 50.0 |
| ZrO₂ | 0.0 to 5.0 |
| Al₂O₃ | 0.0 to 5.0 |
| ZnO | 0.0 to 12.0 |
| CaO | 0.0 to 12.0 |
| BaO | 0.1 to 35.0 |
| SrO | 0.0 to 8.0 |
| Na₂O | 0.0 to 20.0 |
| K₂O | 0.0 to 25.0 |
| Sb₂O₃ | 0.0 to 2.0 |
| As₂O₃ | 0.0 to 2.0 |

### 8. Composition

All of the data below are indicated in cat %:

| | |
|---|---|
| SiO₂ | >0 to <20.0 |
| BO_{1.5} | >0 to <20.0 |
| TiO₂ | 32.0 to 52.0 |
| NbO_{2.5} | 4.0 to 15.0 |
| ZrO₂ | 0 to 11.0 |
| WO₃ | 0 to 5.0 |
| TaO_{2.5} | 0 to 5.0 |
| AlO_{1.5} | 0 to 5.0 |
| SbO_{2.5} | 0 to 0.5 |
| AsO_{2.5} | 0 to 0.5 |
| LaO_{1.5} | 13.0 to 28.0 |
| GdO_{1.5} | 0 to 10.0 |
| YO_{1.5} | 0 to 5.0 |
| YbO_{1.5} | 0 to 5.0 |

### 9. Composition

The following composition enables a glass product with a refractive index nd of 1.95 to 2.05 and a dispersion vd of 22 to less than 35, the fractions being indicated in % by weight:

| | |
|---|---|
| SiO₂ | 4-12 |
| B₂O₃ | 4-11 |
| BaO | <10 |
| La₂O₃ | 30-<52 |
| Gd₂O₃ | <14 |
| ZrO₂ | <5.5 |
| TiO₂ | 10-25 |
| Nb₂O₅ | 3-16 |
| ZnO | ≤2.0 |

where the sum of the weight fractions of SiO₂ and B₂O₃ is at least 10% by weight.

In summary, at least one of the embodiments of the invention can realize at least one of the following advantages and/or provide at least one of the features hereinafter:
simple parametrization of a stable lamella process.
low production costs.
faster production process.
high efficiency.

The invention makes it possible to provide a stable lamella of highly mobile glass. The minimum throughput described is applicable for this purpose.

Although the present invention has been described with reference to preferred working examples, it is not limited thereto, but is instead modifiable in diverse ways.

### LIST OF REFERENCE SIGNS

1 Apparatus
2 Slotted nozzle
3 Discharge roller
3a Discharge surface
4 Cooling device
5 Transport roller
6 Direction of rotation
7 Lamella velocity
8 Discharge roller velocity
9 Impingement region
10 Angle/loop angle
11 Substrate
12 Lamella
13 Shaping device
50 Deflection roller
51 Drawing roller
500 Drawing device
60 Fluid nozzle
601 Fluid stream
S Temperature conditioning section
100 Diagram
101 Normalized throughput
102 Ohnesorge number
201 Unstable region
202, 203 Stable region
204 Limiting throughput
205 Unstable lamella
206 Stable lamella

1-24. (canceled)

25. An apparatus for producing glass, glass-ceramic and/or glass-ceramic material, comprising:
a feeding device for feeding a lamella of a glass and/or glass-ceramic material having a viscosity of between 0.01 Pa s and 100 Pa s to a shaping device, wherein the shaping device comprises a movable discharge surface and a velocity of the movable discharge surface corresponds to 90% or more and 200% or less of a velocity of the fed lamella in a region of impingement of the lamella on the movable discharge surface, and the glass and/or glass-ceramic material as substrate leaves the movable discharge surface.

26. The apparatus of claim 25, wherein the feeding device and the shaping device are configured, depending on an Ohnesorge number
$$Oh = \frac{η}{\sqrt{2 γρ D}}$$
to provide, for the lamella, a minimum throughput m according to the formula
$$\dot{m} ( Oh ) = B \sqrt{2 γρ D} \frac{1 + b \cdot {Oh}^{3}}{1 + a \cdot {Oh}^{3} + b \cdot {Oh}^{4}} ,$$
wherein ρ is a density of the lamella, B is a width of the lamella, D is a thickness of the lamella, η is a viscosity of the lamella, and γ is a surface tension of the lamella, and the parameters a and b≥0.

27. The apparatus of claim 26, wherein the parameter a has a magnitude of between 5 and 500 and the parameter b has a magnitude of between 0 and 200.

28. The apparatus of claim 25, wherein the shaping device is configured in such a way that the substrate on leaving the movable discharge surface has a viscosity of 10² Pa s or more.

29. The apparatus of claim 25, wherein the movable discharge surface is configured in the form of a roller and/or a movable conveyor belt and/or a movable chain.

30. The apparatus of claim 25, wherein the movable discharge surface is a rotatable discharge surface and the substrate, based on an overall circumference of the rotatable discharge surface, loops around the rotatable discharge surface to an extent of at least 1% and 75% or less.

31. The apparatus of claim 25, wherein the feeding device has a slot-shaped nozzle having a maximum width of between 0.05 m and 4 m, a maximum depth of between 1 mm and 50 mm, and a slot width of between 0.2 mm and 5 mm.

32. The apparatus of claim 25, further comprising a temperature conditioning device arranged for temperature-conditioning at least the shaping device.

33. The apparatus of claim 25, wherein the shaping device is configured to provide a contact time of the substrate with the movable discharge surface of 0.01 s or more and 10 s or less.

34. The apparatus of claim 25, further comprising a drawing device downstream of the shaping device and the substrate on leaving the movable discharge surface has a viscosity in a range from 10² Pa s to 10⁵ Pa s.

35. The apparatus of claim 25, wherein the shaping device and/or the movable discharge surface is assigned to a fluid nozzle for detaching the substrate.

36. A method for producing glass, glass-ceramic and/or glass-ceramic material, comprising:
providing a lamella having a viscosity of between 0.01 Pa s and 100 Pa s by a feeding device;
feeding the provided lamella to a movable discharge surface of a shaping device by the feeding device;
providing a velocity of the fed lamella and a velocity of the movable discharge surface relative to the lamella in a region of impingement of the lamella on the movable discharge surface in such a way that a velocity of the movable discharge surface corresponds to 90% or more and 200% or less of the velocity of the fed lamella in the region of impingement of the lamella on the movable discharge surface; and
detaching a substrate from the discharge surface.

37. The method of claim 36, wherein the feeding device and the shaping device are configured so that, depending on the Ohnesorge number
$$Oh = \frac{η}{\sqrt{2 γρ D}}$$
for the substrate of the lamella, a minimum throughput is provided according to the formula
$$\dot{m} ( Oh ) = B \sqrt{2 γρ D} \frac{1 + b \cdot {Oh}^{3}}{1 + a \cdot {Oh}^{3} + b \cdot {Oh}^{4}} ,$$
wherein ρ is a density of the lamella, D is a thickness of the lamella, η is a viscosity of the lamella, and γ is a surface tension of the lamella, and the parameters a and b≥0.

38. The method of claim 37, wherein for the parameter a, a magnitude is selected of between 5 and 500 and for the parameter b, a magnitude is selected of between 0 and 200.

39. The method of claim 36, wherein the movable discharge surface is a rotatable discharge surface and the substrate, based on an overall circumference of the rotatable discharge surface, loops around the rotatable discharge surface to an extent of at least 1% and 75% or less.

40. The method of claim 36, wherein the selected contact time of the substrate with the movable discharge surface is 0.01 s or more and 10 s or less.

41. The method of claim 36, wherein the substrate on leaving the movable discharge surface has a viscosity of 10² Pa s or more.

42. The method of claim 36, wherein the substrate is drawn and/or stretched after leaving the movable discharge surface.

43. The method of claim 42, wherein a thickness of the substrate is adjusted in two stages, firstly by the thickness of the substrate on leaving the movable discharge surface and secondly by a downstream drawing process.

44. The method of claim 43, wherein the substrate is in contact with at least one drawing roller in the drawing process.
